(19) United States
(12) Patent Application Publication
(10) Pub. No.: US 2019/0098051 A1
(43) Pub. Date: Mar. 28, 2019

(54) Systems and Methods of Virtual Honeypots

(71) Applicant: COX COMMUNICATIONS, INC., Atlanta, GA (US)

(72) Inventor: Matthew Edwin Carothers, Dunwoody, GA (US)

(73) Assignee: COX COMMUNICATIONS, INC., Atlanta, GA (US)

(21) Appl. No.: 15/717,900

(22) Filed: Sep. 27, 2017

(51) Int. Cl. H04L 29/06; G06F 9/455

(52) U.S. Cl. CPC H04L 63/1491; H04L 63/1416; G06F 2009/45595; H04L 63/083; G06F 2009/45587; G06F 9/45558

(57) ABSTRACT

Virtual honeypots methods and systems disclosed herein route all IP space of an ISP to a Darknet server as a default. When an IP address is used, it is assigned to a different server. So any IP address left on the Darknet server is an unassigned IP address. All traffic that accesses the Darknet server (the IP unassigned addresses assigned to the Darknet server as a default) is logged. Because those IP addresses are unused, it can be assumed that any traffic that hits them is the result of malicious activity. If malware is scanning the whole internet trying to spread itself, the malware will eventually access the Darknet server with the unassigned IPs.

### TECHNICAL FIELD

The present disclosure is generally related to internet traffic and, more particularly, is related to identifying malicious internet traffic.

### BACKGROUND

Malware or malicious code (malcode) is short for malicious software. It is code or software that is specifically designed to damage, disrupt, steal, or, in general, inflict some other “bad” or illegitimate action on data, hosts, or networks. There are many different classes of malware that have varying ways of infecting systems and propagating themselves. Malware can infect systems by being bundled with other programs or attached as macros to files. Others are installed by exploiting a known vulnerability in an operating system (OS), network device, or other software, such as a hole in a browser that only requires users to visit a website to infect their computers. The vast majority, however, are installed by some action from a user, such as clicking an e-mail attachment or downloading a file from the Internet.

Some of the more commonly known types of malware are viruses, worms, Trojans, bots, back doors, spyware, and adware. Damage from malware varies from causing minor irritation (such as browser popup ads), to stealing confidential information or money, destroying data, and compromising and/or entirely disabling systems and networks.

Two of the most common types of malware are viruses and worms. These types of programs are able to self-replicate and can spread copies of themselves, which might even be modified copies. To be classified as a virus or worm, malware must have the ability to propagate. The difference is that a worm operates more or less independently of other files, whereas a virus depends on a host program to spread itself.

A computer virus is a type of malware that propagates by inserting a copy of itself into and becoming part of another program. It spreads from one computer to another, leaving infections as it travels. Viruses can range in severity from causing mildly annoying effects to damaging data or software and causing denial-of-service (DoS) conditions. Almost all viruses are attached to an executable file, which means the virus may exist on a system but will not be active or able to spread until a user runs or opens the malicious host file or program. When the host code is executed, the viral code is executed as well. Normally, the host program keeps functioning after it is infected by the virus. However, some viruses overwrite other programs with copies of themselves, which destroys the host program altogether. Viruses spread when the software or document they are attached to is transferred from one computer to another using the network, a disk, file sharing, or infected e-mail attachments.

Computer worms are similar to viruses in that they replicate functional copies of themselves and can cause the same type of damage. In contrast to viruses, which require the spreading of an infected host file, worms are standalone software and do not require a host program or human help to propagate. To spread, worms either exploit a vulnerability on the target system or use some kind of social engineering to trick users into executing them. A worm enters a computer through a vulnerability in the system and takes advantage of file-transport or information-transport features on the system, allowing it to travel unaided.

A Trojan is another type of malware named after the wooden horse the Greeks used to infiltrate Troy. It is a harmful piece of software that looks legitimate. Users are typically tricked into loading and executing it on their systems. After it is activated, it can achieve any number of attacks on the host, from irritating the user (popping up windows or changing desktops) to damaging the host (deleting files, stealing data, or activating and spreading other malware, such as viruses). Trojans are also known to create back doors to give malicious users access to the system.

Unlike viruses and worms, Trojans do not reproduce by infecting other files nor do they self-replicate. Trojans must spread through user interaction such as opening an e-mail attachment or downloading and running a file from the Internet.

“Bot” is derived from the word “robot” and is an automated process that interacts with other network services. Bots often automate tasks and provide information or services that would otherwise be conducted by a human being. A typical use of bots is to gather information (such as web crawlers), or interact automatically with instant messaging (IM), Internet Relay Chat (IRC), or other web interfaces. They may also be used to interact dynamically with websites.

Bots can be used for either good or malicious intent. A malicious bot is self-propagating malware designed to infect a host and connect back to a central server or servers that act as a command and control (C&C) center for an entire network of compromised devices, or “botnet.” With a botnet, attackers can launch broad-based, “remote-control,” flood-type attacks against their target(s). In addition to the worm-like ability to self-propagate, bots can include the ability to log keystrokes, gather passwords, capture and analyze packets, gather financial information, launch denial of service (DoS) attacks, relay spam, and open back doors on the infected host. Bots have all the advantages of worms, but are generally much more versatile in their infection vector, and are often modified within hours of publication of a new exploit. They have been known to exploit back doors opened by worms and viruses, which allows them to access networks that have good perimeter control. Bots rarely announce their presence with high scan rates, which damage network infrastructure; instead they infect networks in a way that escapes immediate notice.

Previous steps for protection from malware include OS updates, installation of antivirus software and frequent downloading of updates to ensure that the latest fixes for new viruses, worms, Trojans, and bots have been installed.

A honeypot is a computer security mechanism set to detect, deflect, or, in some manner, counteract attempts at unauthorized use of information systems. Generally, a honeypot consists of data (for example, in a network site) that appears to be a legitimate part of the site, but is actually isolated and monitored, and seems to contain information or a resource of value to attackers, who are then blocked. There are heretofore unaddressed needs with previous honeypot solutions that are addressed by example embodiments of the systems and methods of virtual honeypots disclosed herein.

### SUMMARY

Example embodiments of the present disclosure provide systems of virtual honeypots. Briefly described, in architecture, one example embodiment of the system, among others, can be implemented as follows: a Darknet server configured as a default route for every IP address of a service provider, the Darknet server further configured to receive traffic through unused IP addresses on the Darknet server and identify the traffic to the Darknet server as malicious traffic.

Embodiments of the present disclosure can also be viewed as providing methods for virtual honeypots. In this regard, one embodiment of such a method, among others, can be broadly summarized by the following steps: assigning a Darknet server as a default destination for all IP addresses of a service provider; monitoring traffic sent to unassigned IP addresses on the Darknet server; and identifying the traffic to the unassigned IP addresses on the Darknet server as malicious traffic.

### BRIEF DESCRIPTION OF THE DRAWINGS

FIG. 1 is a system diagram of the IP addresses used by the server in an example embodiment of a system of virtual honeypots.

FIG. 2 is a flow diagram of an example embodiment of a method of virtual honeypots.

FIG. 3 is a flow diagram of an example embodiment of a method of virtual honeypots.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Honeypots are security devices whose value lies in being probed and compromised. Traditional honeypots are servers (or devices that expose server services) that wait passively to be attacked. Client Honeypots are active security devices in search of malicious servers that attack clients. The client honeypot poses as a client and interacts with the server to examine whether an attack has occurred. Often the focus of client honeypots is on web browsers, but any client that interacts with servers can be part of a client honeypot (for example ftp, ssh, email, etc.).

Example embodiments of virtual honeypots disclosed herein select available unused (also known as “dark”) IP space and route any connection requests directed at that space to a server that logs the traffic. Because those IP addresses are unused, it can be assumed that any traffic sent to them is the result of malicious activity. For example, if malware scans the whole internet trying to spread itself, the malware will eventually access the honeypot server with the dark IPs.

In an example implementation, a server may be designated as the default route for all of an Internet provider's IP space. Any IP addresses for that Internet service provider that are unused and unannounced from deeper inside the network will be routed to this server. “Deeper” refers to the network nodes that are closer to end users as opposed to the peering/transit edge where the ISP connects to the rest of the internet (referred to as the ISP's border). The announcements from deeper within the network are for the IP addresses that are in use rather than the dark IPs used for honeypots. Most Darknets are composed of no more than a few hundred IPs, but example embodiments of the disclosed systems and methods of virtual honeypots may use more than a million, for example.

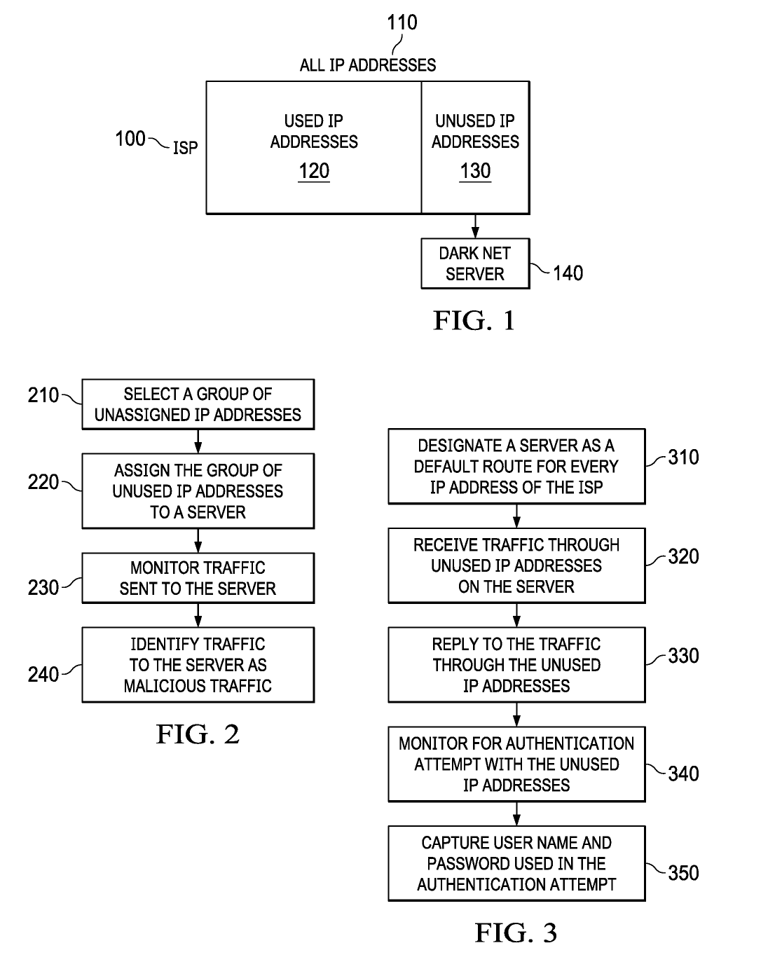

A DarkNet uses dark IP addresses (IP addresses that aren't in use). As provided in FIG. 1, Internet service provider 100 may have several million total IP addresses 110 including used IP addresses 120 and unused IP addresses 130. In an example embodiment of the disclosed systems and methods of virtual honeypots, a portion 130 of these IP addresses 110 may be set aside such that they are not assigned to customers. No devices are assigned to IP addresses 130, so they are currently not in use for anything. The traffic that accesses dark IP addresses 130 may be monitored to identify malware that is scanning IP addresses 130.

An Internet bot, also known as a web robot, or simply bot, is a software application that runs automated tasks or scripts over the Internet. Typically, bots perform tasks that are both simple and structurally repetitive, at a much higher rate than would be possible for a human alone. The largest use of bots is in web spidering (web crawler), in which an automated script fetches, analyzes and files information from web servers at many times the speed of a human. More than half of all web traffic is made up of bots. A particular bot may scan the entire internet including all IP addresses 110 of a particular service provider. Any bot that scans the entire internet is eventually going to land on one of dark IP addresses 130 of the Internet service provider. Since there is now a server assigned to that dark IP address, any traffic to that server is not supposed to be there and can be identified as malware. Currently, one subnet of addresses may be removed from a network, such as a block of a few hundred IP addresses (256 or 512, for example) and those addresses may be assigned directly to a device for monitoring.

According to example embodiments of the systems and methods of virtual honeypots disclosed herein, Darknet server 140 is assigned as the default route for all of unassigned IP addresses 130. If any IP address in the service provider network has not been specifically assigned to somewhere in the network, it is assigned to DarkNet server 140 by default. This allows for the use of every unused IP address 130 on the service provider network for Darknet server 140 instead of assigning specific subnets. In an example implementation, Darknet server 140 may comprise a million and a half IP addresses, whereas a typical current honeypot may comprise a few hundred IP addresses. The odds that a bot lands on IP address in IP addresses 130 in the example implementation is much higher because the number of dark IP addresses 130 is many orders higher than the number of IP addresses using a current implementation.

Mirai is malware that turns networked devices running Linux into remotely controlled bots that may be used as part of a botnet in large-scale network attacks. Mirai primarily targets online consumer devices such as IP cameras and home routers. The Mirai botnet has been used in some of the largest and most disruptive distributed denial of service (DDoS) attacks. Devices infected by Mirai continuously scan the internet for the IP address of Internet of things (IoT) devices. Mirai includes a table of IP address ranges that it will not infect, including private networks and addresses allocated to the United States Postal Service and Department of Defense.

Mirai then identifies vulnerable IoT devices using a table of common factory default usernames and passwords and logs into them to infect them with the Mirai malware. Infected devices will continue to function normally, except for occasional sluggishness and an increased use of bandwidth. A device remains infected until it is rebooted, which may involve simply turning the device off and, after a short wait, turning it back on. After a reboot, unless the login password is changed immediately, the device will be reinfected within minutes. Upon infection Mirai may identify “competing” malware, remove them from memory and block remote administration ports.

There are hundreds of thousands of IoT devices which use default settings, making them vulnerable to infection. Once infected, the device will monitor a command and control server which indicates the target of an attack. The reason for the use of the large number of IoT devices is to bypass some anti-DoS software that monitors the IP address of incoming requests and filters or sets up a block if it identifies an abnormal traffic pattern, for example, if too many requests come from a particular IP address. Other reasons include being able to appropriate more bandwidth than the perpetrator can assemble alone and avoiding being traced.

However, once these devices are identified by example embodiments of the disclosed systems and methods of virtual honeypots, a record of the devices is developed. That record may be sent to other companies so that the service providers with those infected IPs within their customer base can contact the customer and notify them that they may be infected and they can unplug the device.

Additionally, in an example embodiment, as well as monitoring for dark traffic coming in, a reply may be sent to the accessing IP address. Such a reply may be sent to the incoming malware packets using network address translation (NAT) or by routing to virtual machines on Darknet server 140, as two non-limiting examples. Virtual machines running on Darknet server 140 are like servers themselves, but they run in software. All the usual networking methods that are used to route packets on the Internet may be used internally on Darknet server 140 to route packets to virtual machines. By using NAT or routing, multiple IP addresses may be assigned to a single virtual honeypot. This allows a single software program to appear to an attacker as hundreds of different targets. For example, in a virtual honeypot implementation, the server with Darknet IP addresses 130 interacts with the IP address of the malware and collects data on the operations performed. This operation is not just determining the presence of the malware, but also is identifying the operations that are being performed. For example, malware might scan for a Secure Shell (SSH) server, which is a method used to log into devices across the Internet. In an example embodiment, Darknet server 140 may save the user names and passwords that the malware uses to attempt to access devices. This information may also offer a clue as to what kind of devices the malware is attempting to access. For example, one commonly used user name and password combination is username: “root” with password: “calvin”. This is a very distinctive signature for someone trying to log into a Dell server. Another common username and password combination is username: “ubnt” and password: “ubnt” for someone trying to access a Ubiquity Networks device. Another combination is username: “pi” and password: “raspberry” trying to access a Raspberry Pi mini-computer.

In an alternative embodiment, traffic may be sourced from Darknet IP addresses 130. For example, once a website is determined to be malicious, the website may be probed while hiding the identity of the probe by proxying through the server using one of Darknet IP addresses 130. Then, when that Darknet IP address gets banned, another Darknet IP address may be used.

In an alternative embodiment, tunneling may be used to run honeypots on a remote server. Tunneling involves encapsulating IP packets within other IP packets. A packet bound for a dark IP may be transported to a remote server at another ISP anywhere in the world. When a packet is received from an attacker, that attacker packet is encapsulated in an ISP packet and it is tunneled to a remote server by addressing the ISP packet to the remote server. When the remote server replies, the remote server addresses a packet to the attacker but encapsulates it in an packet envelope addressed to the ISP address. The ISP then forwards the packet to the attacker from the recipient of the original packet. That remote server can run honeypots in this way. This technique may be used to share dark IP space with partners and researchers.

FIG. 2 provides a flowchart of an example embodiment of a method of virtual honeypots. In block 210, all unassigned IP addresses are selected from a service provider. In block 220, the unassigned IP addresses are assigned to a Darknet server. In block 230, traffic sent to the Darknet server is monitored. In block 240, the monitored traffic sent to the Darknet server is identified as malicious traffic.

FIG. 3 provides a flowchart of an example embodiment of a method of virtual honeypots. In block 310, a Darknet server is designated as a default route for every IP address of the ISP. In block 320, traffic is received through unused IP addresses on the server. In block 330, the traffic through the unused IP addresses is replied to. In block 340, an authentication attempt with the unused IP addresses is monitored for. In block 350, a user name and password used in the authentication attempt is captured.

The flow chart of FIGS. 2 and 3 show the architecture, functionality, and operation of a possible implementation of the virtual honeypot software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 2 and 3. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A method comprising:
assigning a Darknet server as a default destination for all IP addresses of a service provider;
monitoring traffic sent to unassigned IP addresses on the Darknet server; and
identifying the traffic to the unassigned IP addresses on the Darknet server as malicious traffic.

2. The method of claim 1, wherein the IP addresses on the Darknet server are controlled by the service provider and the unassigned IP addresses comprise every unassigned IP address of the service provider.

3. The method of claim 1, further comprising:
replying to the malicious traffic; and
monitoring a response to the replying.

4. The method of claim 3, wherein monitoring the response comprises capturing the username and password used in the response.

5. The method of claim 3, further comprising identifying the kind of device the malicious traffic is attempting to access.

6. The method of claim 1, further comprising using network address translation or routing to virtual machines on the Darknet server to assign multiple IP addresses to a single virtual honeypot.

7. The method of claim 1, further comprising encapsulating an IP packet within at least one other IP packet and transporting the encapsulated IP packet to a remote server at a second service provider ISP.

8. The method of claim 1, further comprising identifying operations performed by the malicious traffic.

9. A system comprising:
a Darknet server configured as a default route for every IP address of a service provider, the Darknet server further configured to receive traffic through unused IP addresses on the Darknet server and identify the traffic to the Darknet server as malicious traffic.

10. The system of claim 9, wherein the server is further configured to reply to the traffic through the unused IP addresses.

11. The system of claim 10, wherein the server is further configured to monitor for an authentication attempt with the unused IP addresses.

12. The system of claim 11, wherein the server is further configured to capture a user name and password used in the authentication attempt.

13. The system of claim 9, further comprising encapsulating an IP packet within at least one other IP packet and transporting the encapsulated IP packet to a remote server at a second service provider ISP.

14. The system of claim 9, wherein the server is further configured to identify operations performed by the malicious traffic.

15. A computer readable medium, comprising a computer program with instructions for:
assigning a Darknet server as a default destination for all IP addresses of a service provider;
monitoring traffic sent to unassigned IP addresses on the Darknet server; and
identifying the traffic to the unassigned IP addresses on the Darknet server as malicious traffic.

16. The computer readable medium of claim 15, wherein the IP addresses on the Darknet server are controlled by the service provider and the unassigned IP addresses comprise every unassigned IP address of the service provider.

17. The computer readable medium of claim 15, further comprising instructions for:
replying to the malicious traffic; and
monitoring a response to the replying.

18. The computer readable medium of claim 15, wherein instructions for monitoring the response further comprises instructions for capturing the username and password used in the response.

19. The computer readable medium of claim 15, further comprising instructions for encapsulating an IP packet within at least one other IP packet and transporting the encapsulated IP packet to a remote server at a second service provider ISP.

20. The computer readable medium of claim 15, further comprising instructions for identifying operations performed by the malicious traffic.
